(19) United States
(12) Patent Application Publication
(10) Pub. No.: US 2010/0326072 A1
(43) Pub. Date: Dec. 30, 2010

(54) BOOSTER

(76) Inventors: Hideaki ISHII, Minami Alps-shi (JP); Takayuki Ohno, Yokohama-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/824,682

(22) Filed: Jun. 28, 2010

(30) Foreign Application Priority Data
Jun. 30, 2009 (JP) 155917/2009

(51) Int. Cl. B60T 13/20

(52) U.S. Cl. 60/552

(57) ABSTRACT

An input rod and an input piston are advanced in response to an operation of a brake pedal, and an electric motor is driven according to the movement of the input piston to push a primary piston forward in a master cylinder through a ball-screw mechanism, thereby generating desired hydraulic pressures in a primary chamber and a secondary chamber and supplying the hydraulic pressure to the brake caliper of each wheel. At this time, a part of the hydraulic pressure in the primary chamber is received by the input piston to feed back to the brake pedal a part of the reaction force of hydraulic pressure during braking. A retainer of a spring assembly interposed between the primary and secondary pistons has a hollow structure to insert therein the forward end portion of the input piston, thereby allowing a reduction in the axial length of the primary piston.

### BACKGROUND OF THE INVENTION

The present invention relates to a booster for use in an automotive brake mechanism.

Among boosters used in automotive brake mechanisms are known a motor-operated booster that uses an electric motor as a boost source as disclosed in Japanese Patent Application Publication No. 2008-296782. The motor-operated booster drives an electric motor according to the movement of an input piston that moves in response to an operation of a brake pedal and thus pushes a piston forward in a master cylinder through a ball-screw mechanism (rotation-rectilinear motion conversion mechanism), thereby generating and supplying a desired hydraulic pressure to the brake caliper of each wheel. At this time, a part of the hydraulic pressure in the master cylinder is received by an input piston inserted into the master cylinder to slidably extend through the piston, thereby feeding back to the brake pedal a part of the reaction force of hydraulic pressure during braking.

The motor-operated booster disclosed in the above-mentioned Japanese Patent Application Publication No. 2008-296782 has what is called a tandem master cylinder that supplies hydraulic pressures from hydraulic pressure ports of two hydraulic pressure systems by two pistons, i.e. primary and secondary pistons. With the tandem master cylinder, if one of the two hydraulic systems should fail, the braking function can be maintained by the other system. In addition, a spring assembly is interposed between the primary and secondary pistons. The spring assembly comprises a coil spring, spring retainers, and a spring stem connecting between the spring retainers to apply a set load to the coil spring. An input piston extending through the primary piston and the spring stem are disposed in series on the same axis in the master cylinder. Therefore, in order to ensure a sufficient stroke for the input piston while avoiding interference between the input piston and the spring stem, it is necessary to sufficiently increase the length of the primary piston from its master cylinder-side end to a seal section through which the input piston extends. This is against the demand for size reduction of boosters.

### SUMMARY OF THE INVENTION

An object of the present invention is to provide a booster capable of reducing the length of the piston in the master cylinder from its master cylinder-side end to the seal section through which the input piston extends.

To solve the above-described problem, the present invention provides a booster including a master cylinder having a cylinder body of cylindrical shape, one end of which is closed and which has therein a hydraulic pressure chamber generating a hydraulic pressure, an input piston movable to advance and retract in the cylinder body in response to an operation of a brake pedal, a cylindrical piston relatively movably fitted around the input piston, and an actuator advancing and retracting the cylindrical piston. The input piston and the cylindrical piston are inserted in the cylinder body with their respective forward end portions facing into the hydraulic pressure chamber. The hydraulic pressure chamber is provided therein with a spring assembly extending along the axial direction of the master cylinder. The spring assembly has a spring urging the cylindrical piston in a retracting direction and a retainer comprising at least two members inserted into the spring from the opposite ends of the spring and connected together relatively movably in the axial direction to define the maximum length of the spring. The at least two members of the retainer both have hollow interiors allowing insertion therein of the forward end portion of the input piston.

In addition, the present invention provides a booster including a master cylinder having a cylinder body of cylindrical shape, one end of which is closed and which has therein a hydraulic pressure chamber generating a hydraulic pressure, and an input piston having a forward end portion and movable to advance and retract in response to an operation of a brake pedal. The forward end portion of the input piston is inserted in the cylinder body to face into the hydraulic pressure chamber. The booster further includes a cylindrical piston having a forward end portion and relatively movably fitted around the input piston. The forward end portion of the cylindrical piston is inserted in the cylinder body to face into the hydraulic pressure chamber. Further, the booster includes an actuator advancing and retracting the cylindrical piston, and a casing to which the master cylinder is connected. The input piston, the cylindrical piston and the actuator are provided in the casing. The booster further includes a retainer provided in the hydraulic pressure chamber. The retainer has at least two members abutting against the opposite ends, respectively, of a spring urging the cylindrical piston to define the maximum length of the spring. The two members are one member and the other member, which are connected together relatively movably in the axial direction of the master cylinder. The one member abuts against the cylindrical piston, and the other member is disposed away from the cylindrical piston. The other member has an extended cylindrical portion allowing insertion therein of the forward end portion of the input piston when the input piston advances and retracts.

In addition, the present invention provides a booster including a master cylinder having a cylinder body of cylindrical shape, one end of which is closed and which has therein a hydraulic pressure chamber generating a hydraulic pressure, an input piston movable to advance and retract in response to an operation of a brake pedal, a cylindrical piston relatively movably fitted around the input piston, an electric motor generating a rotational force, a rotating member rotated by the rotation of the electric motor, and a rectilinearly moving member converting the rotation of the rotating member into a rectilinear motion in cooperation with a plurality of balls loaded in screw grooves provided on the mutually opposing surfaces of the rectilinearly moving member and the rotating member, thereby advancing and retracting the cylindrical piston. The input piston and the cylindrical piston are inserted in the cylinder body with their respective forward end portions facing into the hydraulic pressure chamber. The hydraulic pressure chamber is provided therein with a spring assembly having a spring urging the cylindrical piston in a retracting direction and a retainer comprising at least two members inserted into the spring from the opposite ends of the spring and connected together relatively movably in the axial direction to define the maximum length of the spring. The at least two members of the retainer both have hollow interiors allowing insertion therein of the forward end portion of the input piston.

### BRIEF DESCRIPTION OF THE DRAWINGS

FIG. 1 is a vertical sectional view of a motor-operated booster according to one embodiment of the present invention.

FIG. 2 is an enlarged view of a master cylinder section of the motor-operated booster shown in FIG. 1.

FIG. 3 is an enlarged view of the master cylinder section of the motor-operated booster in FIG. 1, showing a state where a primary piston, a secondary piston and an input piston are in their maximum stroke positions.

FIG. 4 is an enlarged vertical sectional view of a spring assembly of the motor-operated booster shown in FIG. 1.

FIG. 5 is an enlarged vertical sectional view of a main part of a spring assembly according to another embodiment of the present invention.

FIG. 6 is an enlarged vertical sectional view of a spring assembly according to still another embodiment of the present invention.

### DETAILED DESCRIPTION OF THE INVENTION

One embodiment of the present invention will be explained below in detail with reference to the accompanying drawings.

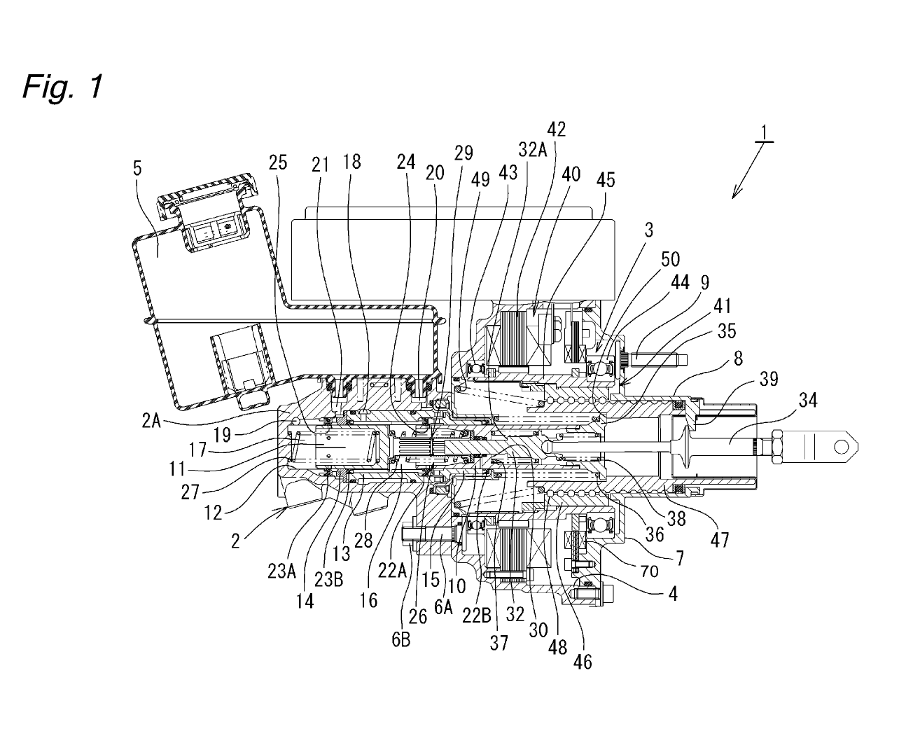

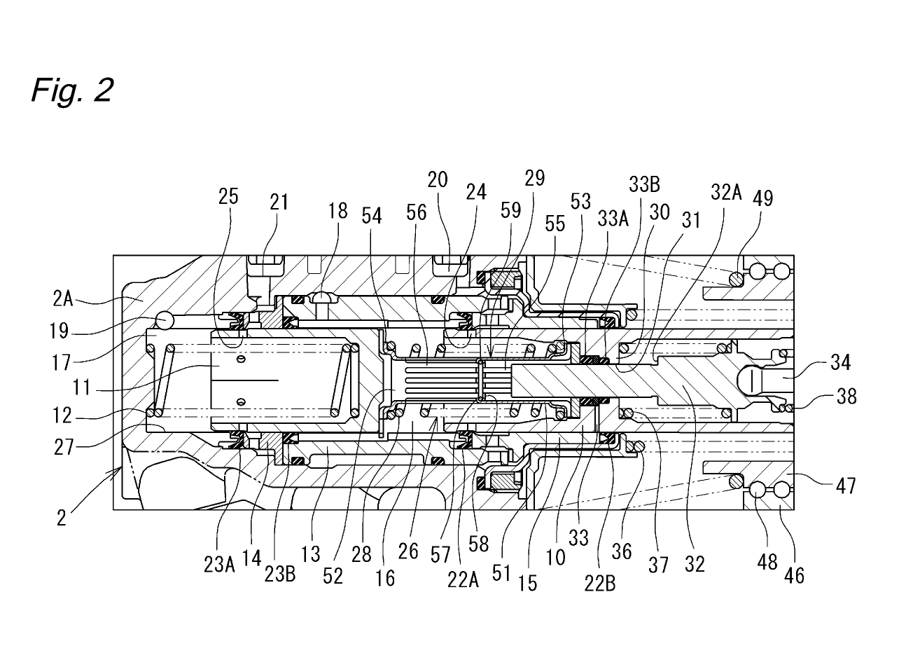

FIG. 1 is a general view of a motor-operated booster 1, which is a booster according to this embodiment. FIG. 2 is an enlarged view of a main part of the motor-operated booster 1 shown in FIG. 1.

As shown in FIGS. 1 and 2, the motor-operated booster 1 has a tandem master cylinder 2 and a casing 4 housing an actuator 3 and a controller (not shown). The master cylinder 2 is connected with a reservoir 5. The master cylinder 2 includes a cylinder body 2A of substantially cylindrical shape, one end of which is closed. The opening end of the cylinder body 2A is connected to the front of the casing 4 with a stud bolt 6A and a nut 6B. The rear of the casing 4 is provided with a flat mounting seat surface 7. A cylindrical guide portion 8 projects from the mounting seat surface 7 in coaxial relation to the master cylinder 2. The motor-operated booster 1 is disposed in an engine room of a vehicle, with the cylindrical guide portion 8 extending into a compartment through a partition between the engine room and the compartment. With the mounting seat surface 7 abutted against the partition, the motor-operated booster 1 is secured by using a stud bolt 9 provided on the mounting seat surface 7.

A cylindrical primary piston 10 (cylindrical piston) having a cup-shaped forward end portion is fitted in the opening end portion of the cylinder body 2A of the master cylinder 2. A cup-shaped secondary piston 11 is fitted in the bottom end portion of the cylinder body 2A. The rear end of the primary piston 10 projects from the opening of the master cylinder 2 into the casing 4 and extends to near the guide portion 8. The primary piston 10 and the secondary piston 11 are slidably guided by annular guide members 14 and 15, respectively. The guide members 14 and 15 are disposed at the opposite ends, respectively, of a sleeve 13 fitted in a cylinder bore 12 of the cylinder body 2A. Two hydraulic pressure chambers, i.e. a primary chamber 16 and a secondary chamber 17, are formed in the cylinder body 2A by the primary piston 10 and the secondary piston 11. The primary chamber 16 and the secondary chamber 17 are provided with hydraulic pressure ports 18 and 19, respectively. The hydraulic pressure ports 18 and 19 are respectively connected with hydraulic pressure circuits of two hydraulic pressure systems for supplying a hydraulic pressure to the brake caliper of each wheel.

The top of the side wall of the cylinder body 2A is provided with reservoir ports 20 and 21 for connecting the primary chamber 16 and the secondary chamber 17 to the reservoir 5. Two seal members 22A and 22B provide a seal between the primary piston 10 and the cylinder bore 12 of the cylinder body 2A. Similarly, two seal members 23A and 23B provide a seal between the secondary piston 11 and the cylinder bore 12 of the cylinder body 2A.

The seal members 22A and 22B are disposed to face each other in the axial direction with the reservoir port 20 interposed therebetween. When the primary piston 10 is in a non-braking position shown in FIGS. 1 and 2, the primary chamber 16 communicates with the reservoir port 20 through a port 24 provided in the side wall of the primary piston 10. When the primary piston 10 advances from the non-braking position, the seal member 22A prevents the communication between the primary chamber 16 and the reservoir port 20.

The seal members 23A and 23B are disposed to face each other in the axial direction with the reservoir port 21 interposed therebetween. When the secondary piston 11 is in a non-braking position shown in FIGS. 1 and 2, the secondary chamber 17 communicates with the reservoir port 21 through a port 25 provided in the side wall of the secondary piston 11. When the secondary piston 11 advances from the non-braking position, the seal member 23A prevents the communication the secondary chamber 17 and the reservoir port 21.

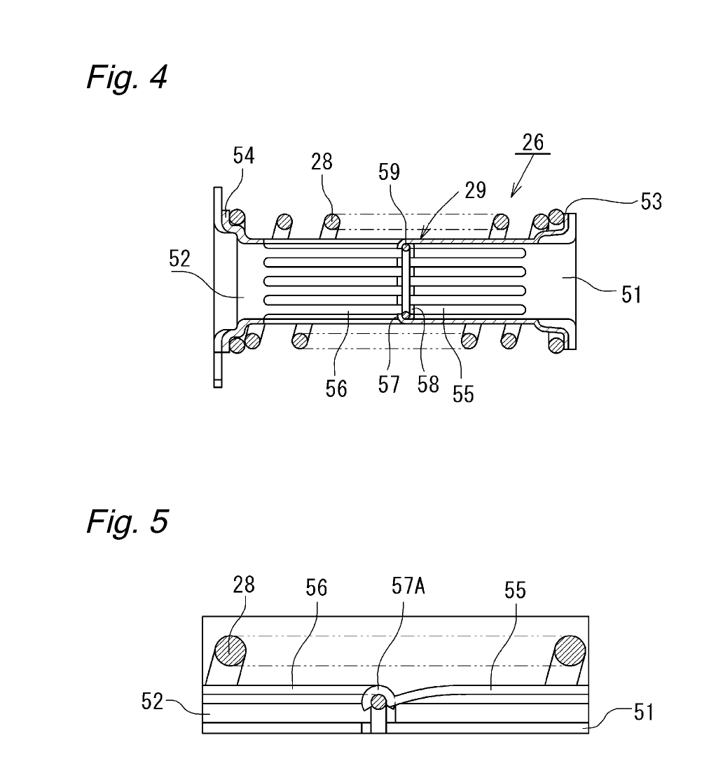

A spring assembly 26 is interposed between the primary piston 10 and the secondary piston 11 in the primary chamber 16. In the secondary chamber 17, a return spring 27 is interposed between the secondary piston 11 and the bottom of the master cylinder 2. The return spring 27 is a compression coil spring. The spring assembly 26 comprises, as shown in FIG. 4, a spring 28, which is a compression coil spring, and an expandable cylindrical retainer 29 retaining the spring 28 in a predetermined compressed state such that the retainer 29 can be compressed against the spring force of the spring 28. The spring assembly 26 will be detailed later.

The primary piston 10 has a cup-shaped forward end portion, a cylindrical rear end portion, and an intermediate wall 30. The intermediate wall 30 extends in the axial direction of the primary piston 10 and also extends in a direction intersecting the axial direction. Thus, the intermediate wall 30 divides the interior of the primary piston 10 into a secondary-piston-side end (forward end) and an opposite side end to the secondary piston (rear end). The secondary-piston-side end of the primary piston 10 constitutes the cup-shaped forward end portion, and the opposite side end of the primary piston 10 constitutes the cylindrical rear end portion.

The intermediate wall 30 has a guide bore 31 extending therethrough in the axial direction. The guide bore 31 is slidably and fluid-tightly fitted with a small-diameter forward end portion of a stepped input piston 32 having a stepped portion 32A. The forward end portion of the input piston 32 is inserted in the cylindrical retainer 29 of the spring assembly 26 in the primary chamber 16. Two seal members 33A and 33B provide a seal between the input piston 32 and the guide bore 31. The intermediate wall 30 of the primary piston 10 has a passage 33 radially extending therethrough to open into the guide bore 31 between the seal members 33A and 33B. The passage 33 is disposed to open between the two seal members 22A and 22B that provide the seal between the primary piston 10 and the cylinder bore 12 of the cylinder body 2A.

The rear end portion of the input piston 32 is connected with the forward end portion of an input rod 34. The forward end portion of the input rod 34 is inserted into the cylindrical guide portion 8 of the casing 4 and the rear end portion of the primary piston 10. The rear end portion of the input rod 34 extends outside from the cylindrical guide portion 8, and a brake pedal (not shown) is connected to the rear end of the input rod 34. A flange-shaped spring retainer 35 is attached to the rear end of the primary piston 10. The primary piston 10 is urged in a retracting direction by a return spring 36, which is a compression coil spring, interposed between the spring retainer 35 and the front wall of the casing 4. The input piston 32 is resiliently held in a neutral position shown in FIGS. 1 and 2 by springs 37 and 38. The spring 37 is interposed between the input piston 32 and the intermediate wall 30 of the primary piston 10. The spring 38 is interposed between the input piston 32 and the spring retainer 35. The retract position of the input rod 34 is defined by a stopper 39 provided at the rear end of the cylindrical guide portion 8 of the casing 4.

The casing 4 is provided therein with an actuator 3 including an electric motor 40 and a ball-screw mechanism 41 that converts the rotation of the electric motor 40 into a rectilinear motion to apply a thrust to the primary piston 10.

The electric motor 40 has a stator 42 fixed to the casing 4 and a hollow rotor 45 that is rotatably supported through bearings 43 and 44 on the casing 4 so as to face the stator 42.

The ball-screw mechanism 41 has a nut member 46, which is a rotating member, fixed to the inner periphery of the rotor 45, a hollow screw shaft 47, and a plurality of balls 48 loaded between screw grooves provided on the mutually opposing surfaces of the nut member 46 and the hollow screw shaft 47. The hollow screw shaft 47 is a rectilinearly moving member that is inserted into both the nut member 46 and the cylindrical guide portion 8 of the casing 4 and that is supported to be axially movable but nonrotatable about the axis. Rotation of the nut member 46 causes the balls 48 to roll along the screw grooves, thereby allowing the screw shaft 47 to move in the axial direction. It should be noted that the ball-screw mechanism 41 allows mutual conversion of a rotary motion and a rectilinear motion between the nut member 46 and the screw shaft 47.

The screw shaft 47 of the ball-screw mechanism 41 is urged in a retracting direction by a return spring 49, which is a tapered compression coil spring, interposed between the screw shaft 47 and the front wall of the casing 4, and the retract position of the screw shaft 47 is limited by the stopper 39 provided on the cylindrical guide portion 8 of the casing 4. The rear end portion of the primary piston 10 is inserted in the screw shaft 47. The retract position of the primary piston 10 is limited by abutment of the spring retainer 35 against a stepped portion 50 formed on the inner periphery of the screw shaft 47. Thus, the primary piston 10 can advance together with the screw shaft 47 and can also advance solely away from the stepped portion 50. As shown in FIGS. 1 and 2, the non-braking position of the primary piston 10 is defined by the stepped portion 50 of the screw shaft 47 abutting against the stopper 39. On the other hand, the retract position of the secondary piston 11, i.e. the non-braking position thereof, is defined by the primary piston 10 and the maximum length of the spring assembly 26 when they are in the non-braking position. The stepped portion 50 of the screw shaft 47 is disposed in the range of the axial length of the nut member 46.

Next, the spring assembly 26 will be detailed with reference to FIG. 4.

As shown in FIG. 4, the spring assembly 26 comprises a spring 28, which is a compression coil spring, and an expandable retainer 29 inserted into the spring 28 to retain the spring 28 in a predetermined compressed state. The retainer 29 comprises two cylindrical retainer members 51 and 52 inserted into the spring 28 from the opposite ends of the spring 28 and connected together axially relatively movably by a stopper member 59.

The retainer members 51 and 52 have cylindrical portions and spring retainer portions 53 and 54, respectively. The spring retainer portions 53 and 54 are each formed at one end of the associated cylindrical portion in the shape of a flange enlarged in diameter to allow each end of the spring 28 to abut thereagainst. The cylindrical portions of the retainer members 51 and 52 respectively have a plurality of axially extending slits formed in their side walls and a plurality of axially extending portions 55 and 56 formed alternately with the slits. Thus, the retainer members 51 and 52 are each in the shape of a comb.

The distal end portions of the axially extending portions 55 and 56 are bent inward in a hook shape to form engaging or latch portions 57 and 58.

The retainer members 51 and 52 have the same diameter at their cylindrical portions that is sufficiently large to allow insertion of the forward end portion of the input piston 32 thereinto.

The retainer members 51 and 52 are circumferentially displaced from each other so that the axially extending portions 55 or 56 of one of the retainer members 51 and 52 are aligned with the slits of the other of the retainer members 51 and 52, and the axially extending portions 55 and 56 and the latch portions 57 and 58 are inserted into the corresponding slits, thereby combining together the retainer members 51 and 52.

The retainer members 51 and 52 combined together as stated above have the ring-shaped stopper member 59 incorporated between the latch portions 57 and 58. The stopper member 59 is, however, joined with only the latch portions 57. Accordingly, when the retainer 29 expands and contracts, the stopper member 59 moves together with the retainer member 51 having the latch portions 57.

With the above-described arrangement, the axially extending portions 55 and 56 and the latch portions 57 and 58 slide in the reciprocating direction along the slits, and the axially extending portions 55 and 56 move relative to each other. Thus, the retainer 29 can expand and contract. The maximum length of the retainer 29 is defined by abutment of the latch portions 57 and 58 against the stopper member 59, and thus the maximum length of the spring 28 is defined. The latch portions 57 and 58 have a radial dimension not larger than the diameter of a wire constituting the stopper member 59 so that the distal ends of the latch portions 57 and 58 extend radially inwardly around the stopper member 59 and are positioned at radially outward sides from the inner periphery of the stopper member 59 not to project radially inward from the inner periphery of the stopper member 59.

The motor-operated booster 1 is provided with a displacement sensor (not shown) detecting a displacement of the input piston 32, a rotational position sensor 70 detecting a rotational position of the rotor 45 of the electric motor 40, hydraulic pressure sensors (not shown) detecting hydraulic pressures in the primary and secondary chambers 16 and 17, respectively, and a controller (housed in the casing 4) controlling the rotation of the electric motor 40 on the basis of detection signals from various sensors including the above-mentioned sensors.

The following is an explanation of the operation of this embodiment arranged as stated above.

When the brake pedal is actuated, the input rod 34 is moved to advance the input piston 32. The displacement sensor detects the displacement of the input piston 32, and the controller controls the operation of the electric motor 40 on the basis of the displacement of the input piston 32, thus causing the primary piston 10 to advance through the ball-screw mechanism 41 following the displacement of the input piston 32. As a result, a hydraulic pressure is generated in the primary chamber 16, and this hydraulic pressure is transmitted to the secondary chamber 17 through the secondary piston 11. The hydraulic pressures in the primary and secondary chambers 16 and 17 are supplied to the brake calipers of the wheels through the hydraulic pressure ports 18 and 19 to generate braking force.

At this time, a part of the hydraulic pressure in the primary chamber 16 is received by the input piston 32, and the reaction force of the input piston 32 is fed back to the brake pedal through the input rod 34. Thus, a desired braking force can be generated with a predetermined boost ratio. In addition, it is possible to obtain a brake pedal reaction force suitable for use during automatic brake control, such as boost control, brake assist control, vehicle stability control, inter-vehicle control, regenerative cooperative control, etc., by properly changing the position at which the movement of the primary piston 10 finishes following the displacement of the input piston 32 and thus the spring forces of the springs 37 and 38 acting on the input piston 32 being adjusted to control the reaction force to the input rod 34.

Because the motor-operated booster 1 has the tandem master cylinder 2, if there should be a failure in one of the two hydraulic pressure systems connected to the hydraulic pressure ports 18 and 19, it is possible to maintain the supply of hydraulic pressure to the other remaining hydraulic pressure system. In this regard, if the hydraulic pressure system connected to the primary chamber 16 fails, the hydraulic pressure in the primary chamber 16 reduces. Consequently, the primary piston 10 compresses the spring assembly 26 against the spring force of the spring 28 and abuts against and advances the secondary piston 11, thereby generating a hydraulic pressure in the secondary chamber 17. If the hydraulic pressure system connected to the secondary chamber 17 fails, the hydraulic pressure in the secondary chamber 17 reduces. Consequently, the secondary piston 11 abuts against the bottom of the master cylinder 2, causing the primary piston 10, the input piston 32 and the return spring assembly 26 to move toward the bottom of the master cylinder 2 together with the secondary piston 11. Further advance of the primary piston 10 from this position generates a hydraulic pressure in the primary chamber 16.

If the actuator 3 should fail, when the input rod 34 is actuated in response to an operation of the brake pedal, the input piston 32 advances, and the stepped portion 32A of the input piston 32 abuts against and presses the intermediate wall 30 of the primary piston 10, causing the primary piston 10 to advance away from the stepped portion 50 of the screw shaft 47 of the ball-screw mechanism 41. Thus, a hydraulic pressure can be generated by manual operation. At this time, the input piston 32 has its forward end portion inserted in the retainer 29 and is allowed to move inside the retainer 29 by a distance corresponding to the distance between the stepped portion 32A and the intermediate wall 30 when the brake pedal is not operated, thereby ensuring the necessary stroke.

If there should be a leakage in the high-pressure side seal member 33A of the two seal members 33A and 33B between the primary piston 10 and the input piston 32, the leaking brake fluid passes through the passage 33 and is led to the area between the two seal members 22A and 22B between the primary piston 10 and the cylinder bore 12 of the master cylinder 2 before being sent to the reservoir 5 through the reservoir port 20. No braking fluid flows into the compartment from the primary piston 10 through the cylindrical guide portion 8 of the casing 4.

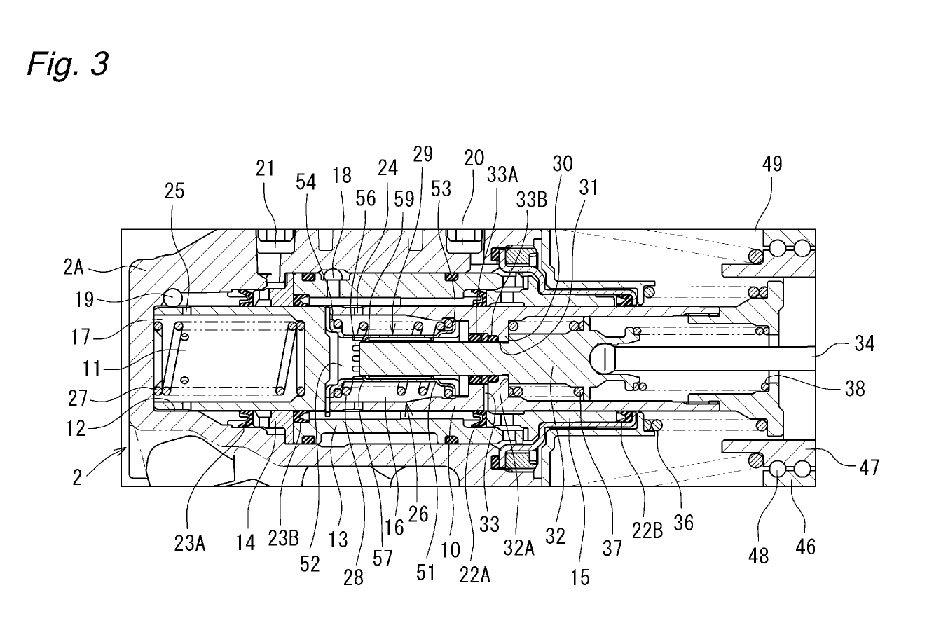

Thus, the present invention has the following structures: the structure in which the forward end portion of the input piston 32 is inserted into the hollow retainer 29 of the spring assembly 26; and the structure in which, when the input piston 32 is in its most advanced position, the input piston 32 is inserted into both the retainer members 51 and 52, which are one and the other retainer members, i.e. all the members of the retainer 29, or alternatively, when the input piston 32 is in its most advanced position, the input piston 32 is inserted into the greater part of the axial range of the retainer member 52, which is the other member of the retainer 29. By virtue of these structures, when the primary piston 10 moves toward the secondary piston 11, as shown in FIG. 3, the forward end portion of the input piston 32 can come close to the secondary piston 11 without interfering with the retainer 29. Consequently, it is possible to reduce the length of the primary piston 10 from its master cylinder-side end to the seal members 33A and 33B (seal section) through which the input piston 32 extends, and hence, the axial dimension of the primary piston 10 can be reduced sufficiently. Accordingly, the slidability of the primary piston 10 can be improved. That is, the primary piston 10 is advanced by being pushed at its rear end by the stepped portion 50 formed on the inner periphery of the screw shaft 47 while the end portion of the primary piston 10 closer to the master cylinder 2 is guided by the guide member 15. Therefore, the smaller the axial dimension of the primary piston 10 (i.e. the distance between the opposite ends thereof), the more difficult for a force couple to be produced, and the easier for the primary piston 10 to move smoothly without encountering resistance.

When the input piston 32 is in the non-braking position shown in FIGS. 1 and 2, the forward end portion of the input piston 32 is inserted in the one retainer member 51 of the retainer 29. When the input piston 32 is in its most advanced position (see FIG. 3), the forward end portion of the input piston 32 is inserted in the other retainer member 52. It should be noted that FIG. 3 shows a state where the primary piston 10 and the secondary piston 11 have moved closest to the bottom of the master cylinder 2. The retainer 29 has the comb-shaped retainer members 51 and 52 combined together and latched by the stopper member 59, thereby allowing the respective cylindrical portions of the retainer members 51 and 52 to have the same diameter. Therefore, the inner diameters of the retainer members 51 and 52 can be maximized with respect to a given outer diameter. It is also possible to commonize the retainer members 51 and 52 and hence possible to reduce the parts count.

It should be noted that the retainer 29 may be formed into a hollow structure by combining together retainer members of different diameters. In this case, each retainer member need not be formed into a comb-like shape and therefore can be formed into a structure providing high strength (e.g. a cylindrical structure).

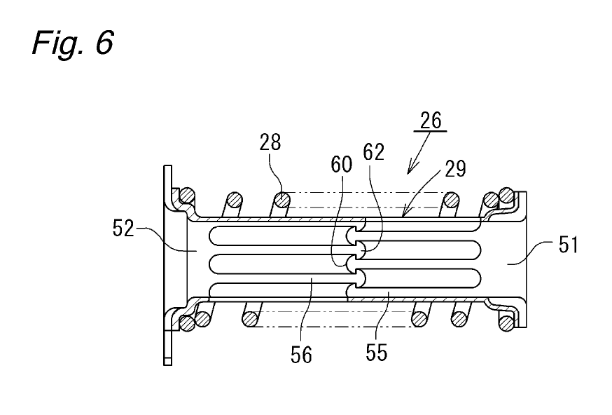

Next, modifications of the spring assembly 26 in the above-described embodiment will be explained with reference to FIGS. 5 and 6. In the following explanation, members or portions similar to those shown in FIG. 4 are denoted by the same reference numerals as used in FIG. 4, and only members or portions in which each modification differs from the foregoing embodiment will be explained in detail.

In the modification shown in FIG. 5, an engaging or latch portion 57A at the forward end of the axially extending portion 55 of the one retainer member 51 is formed to be wound around substantially half the circumference of the stopper member 59, and the stopper member 59 is retained by the latch portion 57A. Thus, when the retainer 29 is contracted, the stopper member 59 is retained even more surely by the latch portion 57A of the one retainer member 51 and is therefore unlikely to tilt or fall off. Accordingly, the retainer 29 can perform a stable expansion-contraction operation.

In the modification shown in FIG. 6, the stopper member 59 is omitted. The retainer members 51 and 52 have their slits widened in width, and the axially extending portions 55 and 56 have circumferentially extending semicircular latch portions 60 and 61 formed at their respective distal ends. When the combined retainer members 51 and 52 are moved away from each other in the expanding direction of the retainer 29, the latch portions 60 and 61 of each pair of adjacent axially extending portions 55 and 56 engage with each other to restrain the movement of the retainer members 51 and 52. Thus, the need for the stopper member 59 is eliminated, and the effective inner diameter of the retainer 29 can be increased correspondingly.

Although, in the foregoing, the retainer 29 of the spring assembly 26 is formed by combining together two members (retainer members 51 and 52), three or more retainer members may be expandably connected together into a hollow structure to define the maximum length of the spring 28.

Although in the foregoing embodiment the present invention has been explained as a motor-operated booster equipped with a tandem master cylinder 2 having hydraulic pressure ports 18 and 19 of two hydraulic pressure systems, by way of example, the present invention is not limited thereto but applicable to a motor-operated booster using a single-type master cylinder without the secondary piston 11 and the secondary chamber 17. Although the foregoing embodiment uses the actuator 3 comprising the electric motor 40 and the ball-screw mechanism 41, it is also possible to use other publicly known actuators (e.g. an electromagnetic actuator using a solenoid or the like, a pneumatic actuator, or a hydraulic actuator).

According to the booster of the above-described embodiment, it is possible to reduce the length of the piston in the master cylinder from its master cylinder-side end to the seal section through which the input piston extends.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2009-155917 filed on Jun. 30, 2009.

The entire disclosure of Japanese Patent Application No. 2009-155917 filed on Jun. 30, 2009 including specification, claims, drawings and summary is incorporated herein by reference in its entirety.

What is claimed is:

1. A booster comprising:
a master cylinder having a cylinder body of cylindrical shape, one end of which is closed and which has therein a hydraulic pressure chamber generating a hydraulic pressure;
an input piston movable to advance and retract in the cylinder body in response to an operation of a brake pedal;
a cylindrical piston relatively movably fitted around the input piston; and
an actuator advancing and retracting the cylindrical piston;
the input piston and the cylindrical piston being inserted in the cylinder body with their respective forward end portions facing into the hydraulic pressure chamber;
the hydraulic pressure chamber being provided therein with a spring assembly extending along an axial direction of the master cylinder, the spring assembly having a spring urging the cylindrical piston in a retracting direction and a retainer comprising at least two members inserted into the spring from opposite ends of the spring and connected together relatively movably in the axial direction to define a maximum length of the spring;
the at least two members of the retainer both having hollow interiors allowing insertion therein of the forward end portion of the input piston.

2. The booster of claim 1, wherein the input piston is inserted in one of the members of the retainer when the brake pedal is not operated.

3. The booster of claim 2, wherein the input piston is inserted in all the members of the retainer when the input piston moves to a most advanced position in response to an operation of the brake pedal.

4. The booster of claim 1, wherein the cylindrical piston has an intermediate wall with a guide bore through which the input piston extends, the input piston having a stepped portion that abuts against the intermediate wall when the input piston moves relative to the cylindrical piston;
the input piston being movable inside the retainer by at least a distance corresponding to a distance between the stepped portion and the intermediate wall when the brake pedal is not operated.

5. The booster of claim 4, wherein the intermediate wall is provided with at least two seal members providing a seal between the guide bore and the input piston, an area between the at least two seal members being connected to a reservoir of the master cylinder through a radial passage provided in the intermediate wall.

6. The booster of claim 1, wherein the cylinder body is provided therein with a secondary piston between a bottom of the cylinder body and the cylindrical piston;
the spring assembly being disposed in a hydraulic pressure chamber between the cylindrical piston and the secondary piston to define a position of the secondary piston with respect to the cylindrical piston.

7. The booster of claim 1, wherein the two members of the retainer have a same inner diameter and have respective axially extending portions arranged alternately in a circumferential direction and latch portions provided at distal ends of the axially extending portions to latch the two members to each other.

8. The booster of claim 1, wherein the actuator includes an electric motor generating a rotational force and a rotation-rectilinear motion conversion mechanism that converts rotation of the electric motor into a rectilinear motion to move the cylindrical piston.

9. The booster of claim 8, wherein the rotation-rectilinear motion conversion mechanism is a ball-screw mechanism;
the ball-screw mechanism including a rotating member rotated by the rotation of the electric motor, a rectilinearly moving member rectilinearly moving in abutment against the cylindrical piston, and a plurality of balls loaded in screw grooves provided on mutually opposing surfaces of the rotating member and the rectilinearly moving member;
the rectilinearly moving member and the cylindrical piston abutting against each other at a point in a range of an axial length of the rotating member.

10. A booster comprising:
a master cylinder having a cylinder body of cylindrical shape, one end of which is closed and which has therein a hydraulic pressure chamber generating a hydraulic pressure;
an input piston having a forward end portion and movable to advance and retract in response to an operation of a brake pedal, the forward end portion being inserted in the cylinder body to face into the hydraulic pressure chamber;
a cylindrical piston having a forward end portion and relatively movably fitted around the input piston, the forward end portion being inserted in the cylinder body to face into the hydraulic pressure chamber;
an actuator advancing and retracting the cylindrical piston; and
a casing to which the master cylinder is connected;
the input piston, the cylindrical piston and the actuator being provided in the casing;
the booster further comprising:
a retainer provided in the hydraulic pressure chamber;
the retainer having at least two members abutting against opposite ends, respectively, of a spring urging the cylindrical piston to define a maximum length of the spring, the two members being one member and the other member, the one member and the other member being connected together relatively movably in an axial direction of the master cylinder;
the one member abutting against the cylindrical piston, the other member being disposed away from the cylindrical piston;
the other member having an extended cylindrical portion allowing insertion therein of the forward end portion of the input piston when the input piston advances and retracts.

11. The booster of claim 10, wherein the forward end portion of the input piston is inserted in the one member of the retainer when the brake pedal is not operated.

12. The booster of claim 11, wherein the input piston is inserted into a greater part of an axial range of the other member of the retainer when the input piston moves to a most advanced position in response to an operation of the brake pedal.

13. The booster of claim 10, wherein the cylindrical piston has an intermediate wall with a guide bore through which the input piston extends, the input piston having a stepped portion that abuts against the intermediate wall when the input piston moves relative to the cylindrical piston;
the input piston being movable inside the retainer by at least a distance corresponding to a distance between the stepped portion and the intermediate wall when the brake pedal is not operated.

14. The booster of claim 13, wherein the intermediate wall is provided with at least two seal members providing a seal between the guide bore and the input piston, an area between the at least two seal members being connected to a reservoir of the master cylinder through a radial passage provided in the intermediate wall.

15. The booster of claim 10, wherein the cylinder body is provided therein with a secondary piston between a bottom of the cylinder body and the cylindrical piston;
the retainer being disposed in a hydraulic pressure chamber between the cylindrical piston and the secondary piston to define a position of the secondary piston with respect to the cylindrical piston.

16. The booster of claim 10, wherein the actuator includes an electric motor generating a rotational force and a rotation-rectilinear motion conversion mechanism that converts rotation of the electric motor into a rectilinear motion to move the cylindrical piston.

17. A booster comprising:
a master cylinder having a cylinder body of cylindrical shape, one end of which is closed and which has therein a hydraulic pressure chamber generating a hydraulic pressure;
an input piston movable to advance and retract in response to an operation of a brake pedal;
a cylindrical piston relatively movably fitted around the input piston;
an electric motor generating a rotational force;
a rotating member rotated by the rotation of the electric motor; and
a rectilinearly moving member converting rotation of the rotating member into a rectilinear motion in cooperation with a plurality of balls loaded in screw grooves provided on mutually opposing surfaces of the rectilinearly moving member and the rotating member, thereby advancing and retracting the cylindrical piston;
the input piston and the cylindrical piston being inserted in the cylinder body with their respective forward end portions facing into the hydraulic pressure chamber;
the hydraulic pressure chamber being provided therein with a spring assembly having a spring urging the cylindrical piston in a retracting direction and a retainer comprising at least two members inserted into the spring from opposite ends of the spring and connected together relatively movably in the axial direction to define a maximum length of the spring;
the at least two members of the retainer both having hollow interiors allowing insertion therein of the forward end portion of the input piston.

18. The booster of claim 17, wherein the input piston is inserted into all the members of the retainer when the input piston moves to a most advanced position in response to an operation of the brake pedal.

19. The booster of claim 17, wherein the cylindrical piston has an intermediate wall with a guide bore through which the input piston extends, the input piston having a stepped portion that abuts against the intermediate wall when the input piston moves relative to the cylindrical piston;
the input piston being movable inside the retainer by at least a distance corresponding to a distance between the stepped portion and the intermediate wall when the brake pedal is not operated.

20. The booster of claim 17, wherein the cylinder body is provided therein with a secondary piston between a bottom of the cylinder body and the cylindrical piston;
the spring assembly being disposed in a hydraulic pressure chamber between the cylindrical piston and the secondary piston to define a position of the secondary piston with respect to the cylindrical piston.
